(19) United States
(12) Patent Application Publication
(10) Pub. No.: US 2025/0330500 A1
(43) Pub. Date: Oct. 23, 2025

(54) INTER-VEHICLE COMMUNICATION SYSTEM

(71) Applicant: Carszy Inc., Huntington Beach, CA (US)

(72) Inventor: Samit Banerjee, Huntington Beach, CA (US)

(21) Appl. No.: 18/641,997

(22) Filed: Apr. 22, 2024

(51) Int. Cl. H04L 65/1073; H04W 4/08; H04W 4/46

(52) U.S. Cl. CPC H04L 65/1073; H04W 4/08; H04W 4/46

(57) ABSTRACT

An inter-vehicle communication system enables users to exchange messages, view locally-relevant information, and/or receive alerts. The system uses vehicle license plate numbers as an identifier for routing messages and other information to appropriate users. Note that although the term “license plate number” is used for convenience, it should be understood that this may include any combination of letters, numbers, or other characters displayed on a vehicle that identify the vehicle. Any given license plate number may be associated with multiple users and any given user may be associated with multiple license plate numbers. By modifying stored associations between users and license plate numbers, the ownership of a vehicle and other statuses of users relative to the vehicle (e.g., driver, passenger, etc.) may be updated. Thus, messages intended for a specified vehicle may be routed to the correct user or users.

### BACKGROUND

### 1. Technical Field

The subject matter described relates generally to communications systems and, in particular, to an inter-vehicle communication system that uses license plates as an identifier for message routing.

### 2. Background Information

Motor vehicles enable people to travel large distances in relatively short periods of time. The rise of the personal car in the 20th Century provided numerous opportunities for individuals to travel between locations at will. Whether it is a daily commute from a person's home to their office and back again, a visit to a store to get groceries, or a road trip to visit friends and family, people often spend large amounts of time in motor vehicles.

The availability of internet-connected mobile devices has enabled large amounts of information to be made available to people at almost any location. Social networks provide communication between friends, family, colleagues, classmates, and acquaintances, etc., and search engines provide access to a wide range of information. However, the connectivity and access to data provided by the internet may not be readily accessible to those traveling in motor vehicles.

When traveling in a motor vehicle, existing technology makes it challenging to identify others in the vicinity with which to communicate and access locally-relevant information. While travelers often see other vehicles on the road, they have no information about the occupants of those vehicles and thus no way to communicate with them. Furthermore, when individuals or groups are in an unknown location, they often do not know what information to look for, and thus cannot make use of search engines to locate locally-relevant information.

### SUMMARY

An inter-vehicle communication system enables users to exchange messages, view locally-relevant information, and/or receive alerts. The system uses vehicle license plate numbers as an identifier for routing messages and other information to appropriate users. Note that although the term “license plate number” is used for convenience, it should be understood that this may include any combination of letters, numbers, or other characters displayed on a vehicle that identify the vehicle. Any given license plate number may be associated with multiple users and any given user may be associated with multiple license plate numbers. By modifying stored associations between users and license plate numbers, the ownership of a vehicle and other statuses of users relative to the vehicle (e.g., driver, passenger, etc.) may be updated. Thus, messages intended for a specified vehicle may be routed to the correct user or users.

### BRIEF DESCRIPTION OF THE DRAWINGS

FIG. 1 is a block diagram of an inter-vehicle communication system, according to one embodiment.

FIG. 2 is a block diagram of a client device suitable for use in inter-vehicle communication system of FIG. 1, according to one embodiment.

FIG. 3 is a block diagram of the server of FIG. 1, according to one embodiment.

FIG. 4 is a block diagram of the database of FIG. 3, according to one embodiment.

FIG. 5 illustrates virtual garages that indicate relationships between users and vehicles, according to one embodiment.

FIGS. 6A and 6B are interaction diagrams of methods for registering an unregistered vehicle to a user, according to one embodiment.

FIGS. 7A and 7B are interaction diagrams of methods for registering an already registered vehicle to a user, according to one embodiment.

FIGS. 8A and 8B are interaction diagrams of methods for sending messages using a vehicle's license plate as an identifier, according to one embodiment.

FIG. 9 is an interaction diagram of a method for distributing an alert to a driver, according to one embodiment.

FIG. 10 is an interaction diagram of a method for providing human media to a driver, according to one embodiment.

FIG. 11 is a block diagram illustrating an example of a computer suitable for use as a server or client device, according to one embodiment.

### DETAILED DESCRIPTION

The figures and the following description describe certain embodiments by way of illustration only. One skilled in the art will readily recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

### OVERVIEW

Conventional electronic communication systems typically rely on a one-to-one correspondence between identifiers used for routing messages and recipients. For example, an email address or social network username uniquely identifies a single user, so sending a message to that user is simply a matter of providing the email address or username along with the content of the message and the system automatically routes the message to the intended recipient. However, when drivers want to communicate with others on the road, they typically only have identifying information for a vehicle, such as a license plate number and issuing state, make and model, color, and the like. Such information can uniquely identify the vehicle but does not uniquely identify a user. Multiple users may correspond to a single vehicle (e.g., all members of a family may drive the same car at different times). To further complicate matters, any given user may be associated with multiple vehicles (e.g., a hatchback for the commute to work, an SUV for family trips, and classic car that is taken to rallies). In other words, vehicles in general have a many-to-many relationship with users.

The disclosed inter-vehicle communication system enables users to initiate communication using a license plate to identify the intended recipient or recipients. In one embodiment, a user provides the license plate number of a vehicle (e.g., by taking a photograph including the license plate with a smartphone or other mobile computing device). A license plate recognition algorithm extracts a text representation of the license plate from the image. The user may then either send a message to the vehicle, which will be routed to computing devices of some or all users associated with the vehicle or view a vehicle profile that identifies the users associated with the vehicle and select one or more to which the message should be routed.

In addition, the system may search an alerts database using the license plate number to determine if there are any active alerts associated with the vehicle. Information about any active alerts may be displayed to the user. For example, if the vehicle has been reported stolen, as having been involved in a hit and run, or in relation to an Amber Alert, the user may be provided with pertinent information and given an opportunity to contact the appropriate authorities.

The system may also provide a user with personalized “human media” that includes messages posted to the user (e.g., comments, photos, etc.) as well as geo-aware content. The system may be aware of the user's current location (e.g., by receiving location information from a GPS system in the user's vehicle or computing device) and provide content pertinent to the user's current location as human media. Example of such geo-aware content include recommendations for local restaurants and attraction, special offers at local establishments, notifications of events (e.g., road closures, hit and runs, concerts, sporting events, etc.), and alerts (e.g., Amber Alerts, weather warnings, etc.).

### Example Systems

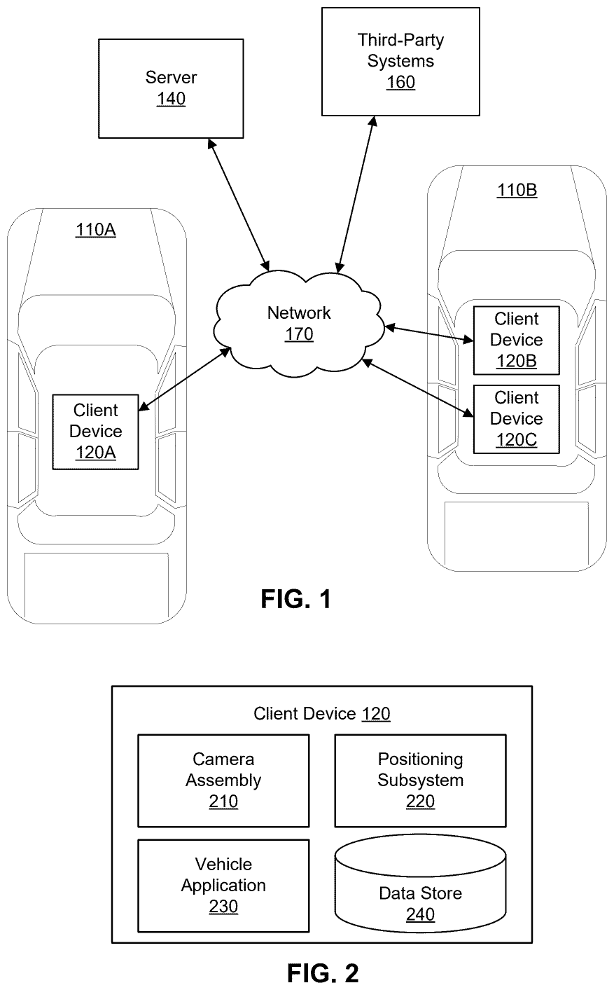

FIG. 1 illustrates one embodiment of an inter-vehicle communication system suitable for providing inter-vehicle communication. In the embodiment shown, the networked computing environment includes client devices 120, a server 140, and one or more third party systems 160, all connected via a network 170. Three client devices 120 are depicted in FIG. 1. A first client device 120A is located within a first vehicle 110A while a second client device 120B and a third client device 120C are located within a second vehicle 110B. However, the inter-vehicle communication system may include any number of client devices 120, some or all of which may be within vehicles 110. In other embodiments, the inter-vehicle communication system includes different or additional elements. In addition, the functions may be distributed among the elements in a different manner than described.

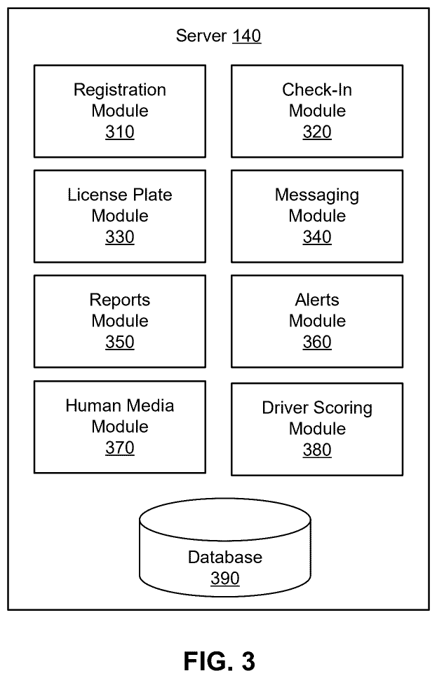

The client devices 120 are computing devices with which users can send and receive messages and access other functionality of the inter-vehicle communication system. The client devices 120 are typically smartphones. However, other computing devices may be used, such as tablets, personal digital assistants, navigation devices, and built-in vehicle computers. Various embodiments of the client devices 120 are described in greater detail below, with reference to FIG. 2.

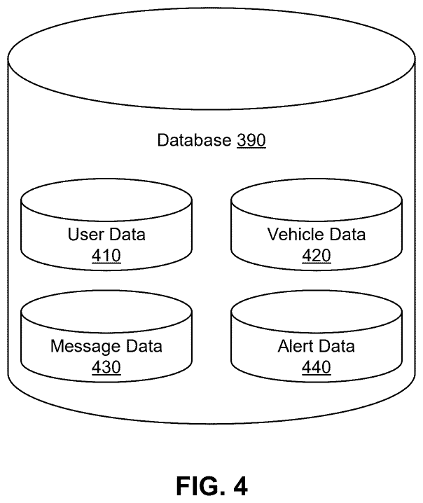

The client devices 120 connect to the server 140 via the network 170. The server 140 manages the distribution of information within the inter-vehicle communication system to the client devices 120. For example, the server 140 may route messages from sending client devices (e.g., client device 120A) to receiving client devices (e.g., client devices 120B and 120C), aggregate and provide information for display to a user as human media, generate alerts, and supply any other appropriate information to client devices 120. Various embodiments of the server 140 are described in greater detail below, with reference to FIG. 3.

The inter-vehicle communication system can also include one or more third-party system 160. A third-party system generates information that can be made available to client devices 120 by the server 140. For example, a business may submit a special offer that it makes available to users and specify a geographic region to which it applies (e.g., by providing a ZIP code, identifying geographic coordinates and a radius around those coordinates, defining a ring fence, or using any other appropriate method). The server 140 may then cause the special offer to be displayed as human media when the user is in the specified geographic region. As another example, a parking lot may submit images of license plates of cars in the lot (e.g., as captured by a camera at an entrance) and provide information about parking rates, local businesses, operating hours, or any other desired information to client devices 120 of users associated with the vehicles 110 in the parking lot.

The network 170 provides the communication channels via which the other elements of the inter-vehicle communication system communicate. The network 170 is typically the internet but can include any combination of local area and/or wide area networks, using both wired and/or wireless communication systems. In one embodiment, the network 170 uses standard communications technologies and/or protocols. For example, the network 170 can include communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 170 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 170 may be represented using any suitable format, such as hypertext markup language (HTML) or extensible markup language (XML). In some embodiments, all or some of the communication links of the network 170 may be encrypted using any suitable technique or techniques.

FIG. 2 illustrates one embodiment of a client device 120 suitable for use in the inter-vehicle communication system. In the embodiment shown, the client device 120 includes a camera assembly 210, a positioning subsystem 220, a vehicle application (a “vehicle app”) 213, and a data store 240. In other embodiments, the client device 120 includes different or additional elements. In addition, the functions may be distributed among the elements in a different manner than described.

The camera assembly 210 includes one or more cameras that can capture images of the environment around the client device 120. The cameras may be built in or connected to the client device 120. In the case where the client device 120 is a built-in vehicle computer, the cameras may be mounted or installed on the vehicle 110. The positioning subsystem 220 determines the geo-spatial location of the client device 120. In one embodiment, the positioning subsystem 220 is a global positioning system (GPS). Additionally or alternatively, the positioning subsystem 220 may use other technologies and techniques to determine or refine the position of the client device 120, such as cell tower triangulation, Wi-Fi positioning, dead reckoning, and the like.

The vehicle app 230 is software or firmware that executes on the client device 120. The vehicle app 210 provides a user interface with which the user can send and receive messages and access other functionality provided by the inter-vehicle communication system. The vehicle app 230 can include social media functionality, such as the ability to form connections with other users and share content with other individual users and groups of users (including sharing content to be viewed by all of a user's contacts within the vehicle app 230).

In one embodiment, a user can initiate sending a message from the vehicle app 230 (e.g., by selecting a button or other control in the user interface). The vehicle app 230 prompts the user to provide a license plate number. The user may provide the license plate number by taking a photograph of a license plate (e.g., using the camera assembly 210). An automated license plate identification algorithm may be used to extract the license plate number from the image. The algorithm may first use a segmentation model (e.g., a machine-learned model) to identify the portion of the image that includes the license plate, process the identified portion of the image (e.g., by adjusting the contrast, converting it to black and white, applying skew correction, and the like), and apply an optical character recognition algorithm to extract the license plate number. The extracted license plate number may be presented to the user for confirmation or editing.

Alternatively, the user may enter the license plate number manually (e.g., using a keyboard or speech-to-text). The user may also be prompted to identify the entity (e.g., a state, province, or country) that issued the license plate to disambiguate potential clashes. For example, in the United States, each state issues its own license plates and there is no guarantee that duplicate license plate numbers have not been issued by different states. In some embodiments, where the license plate number is extracted from a photo, the issuing entity may be identified automatically (e.g., using a machine-learned classifier that can distinguish between the license plates issued by different states). Regardless of precisely how it is provided, the client device 120 sends the license plate number (and the identity of the issuing entity where available) to the server 140 for further processing.

In response to providing the license plate number, the client device 120 receives a vehicle profile with available information about the vehicle 110. The vehicle profile may identify other users of the inter-vehicle communication system associated with the vehicle 110, such as the owner, driver(s), and any passengers. Users may be provided with privacy settings to control whether strangers (i.e., other users with whom they have not yet established a connection within the vehicle app 230) can view their association with the vehicle 110. In one embodiment, the user may elect to send a message to the vehicle 110, which will be routed to some or all of the users associated with vehicle (e.g., based on preferences set by the owner of the vehicle), or to a specified user selected from those identified in the vehicle profile (where the relevant privacy setting allow the sending user to see which users are associated with the vehicle). For example, the user may elect to message just the current driver of the vehicle. In some embodiments, the user is initially limited to sending messages from a predetermined set of default messages unless/until the recipient agrees (e.g., by setting a parameter in the vehicle app 230) to receive messages with custom content (e.g., free text, photographs, videos, etc.) from the user. This provides protection against users receiving unsolicited spam or abusive messages from other users (e.g., as a result of road rage).

The vehicle profile may also indicate if there are any alerts associated with the vehicle 210, such as reports that the vehicle is stolen or was involved in a hit-and-run or is a vehicle of interest in relation to an Amber Alert or crime. Where there is an alert associated with the vehicle 210, the vehicle app 230 may provide information or controls to make it easy for the user to contact the relevant authorities. For example, the vehicle app 230 may display the phone number of the local police department (as determined from the position of the client device 120 determined by the positioning subsystem 220) or provide a button that opens a phone app with an emergency number (e.g., 911) preloaded so that the user only needs to press “dial.”

In some embodiments, the vehicle app 230 also provides a user with human media. The user's human media can include social content generated by other users (e.g., messages and comments shared by the user's contacts) as well as geo-aware content. In one embodiment, the vehicle app 230 sends the geo-spatial location client device 120 provided by the positioning subsystem 220 to the server 140 which returns items of potential interest in the vicinity of the client device 120 for display as human media. These items may include attractions, events, alerts, special offers, and any other location-specific information that may be of value to the user.

In some embodiments, the vehicle app 230 may also provide certain alerts to the user unprompted. To this end, the vehicle app 230 may periodically provide the client device's location to the server 140 and if certain types of alert (e.g., Amber Alerts, severe weather warnings, road closures, etc.) are active in the vicinity of the client device, a push notification may be generated regarding the alert. The vehicle app 230 may draw the user's attention to the alert by triggering an audio or visual indication (e.g., a bell chime or flashing light) in response to receiving the push notification.

The data store 240 includes one or more computer-readable media configured to store data and software used by the client device 120. For example, the data store 240 may be a solid-state memory that stores the vehicle application 230 and images captured by the camera assembly 210. In some embodiments, users may initiate communication with a vehicle using a previously captured photograph of the vehicle's license plate stored on the data store 240. The data store 240 may also be used to cache information such as previously received messages for rapid retrieval and display.

FIG. 3 illustrates one embodiment of the server 140. In the embodiment shown, the server 140 includes a registration module 310, a check-in module 320, a license plate module 330, a messaging module 340, a reports module 350, an alerts module 360, a human media module 370, a driver scoring module 380, and a database 390. In other embodiments, the client device 120 includes different or additional elements. In addition, the functions may be distributed among the elements in a different manner than described.

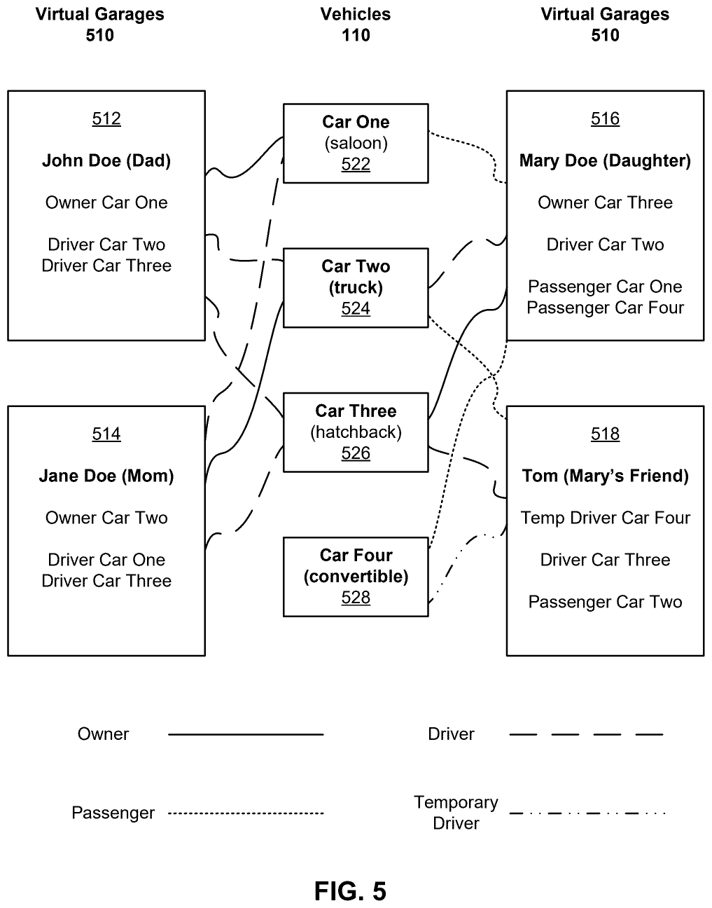

The database 390 includes one or more computer-readable media configured to store data used by the server 140 in providing the disclosed functionality to client device 120. Although the database 390 is depicted as a single entity within the server 130, the database may be stored across multiple computing devices (e.g., in a distributed database) that are accessed via the network 170. In one embodiment, as shown in FIG. 4, the database 390 includes user data 410, vehicle data 420, message data 430, and alert data 440. The database 390 also stores relationships between data.

The user data 410 includes user profiles for the users of the inter-vehicle communication system. In one embodiment, the user profile for a user includes a unique identifier of the user (e.g., a username or userID), a photo or avatar, biographical information, and/or any other appropriate information. Similarly, the vehicle data 420 includes vehicle profiles for vehicles 110 and may include information about the vehicle such as: a unique identification of the vehicle (e.g., a license plate number and state of registration), a make and model, a year of manufacture, a color, and the like. Associations between specific users and vehicles 110 may be stored in either the user data 410, the vehicle data 420, or both.

The message data 430 includes the content and routing information of messages sent using the inter-vehicle communication system. The routing information can include an identifier of the sender, identifiers of one or more recipient users, and/or identifiers of a recipient vehicle. Where the message content was selected from a set of predetermined messages, the message data 430 may store just an identifier of the predetermined message. In contrast, if the message include user-provided content, the message data 430 includes the user-provided content.

The alert data 440 includes data regarding alerts. Depending on the specific type of alert, the alert data 440 may include a time range for which the alert is active (e.g., a start an end time, or just an end time indicating the alert is active from the time it was created until the end time), a geographic area to which the alert corresponds, a type of the alert (e.g., whether the alert is an Amber Alert, a weather advisory, a road closure, a commercial offer, etc.), and custom content to display to users who view the alert (e.g., text explaining a road closure and diversion, images of a missing child and a suspect vehicle for an Amber Alert, a link to a business's website for a commercial offer, etc.).

Referring again to FIG. 3, the registration module 310 registers users to roles with regard to vehicles 110 based in user input received from the client devices 120 (e.g., by storing or updating associations between the users and vehicles in the database 390). Generally, a user registers by identifying a vehicle 110 (e.g., by providing a license plate number and issuing authority) and specifying a role they have in relation to that vehicle. In one embodiment, there are four roles a user may have: owner, driver, passenger, and temporary driver. In other embodiments, the registration module 310 supports different or additional roles.

An owner of a vehicle 110 has administrative control of it within the inter-vehicle communication system. An owner can approve the addition of other users as drivers, passengers, or temporary drivers. Generally, there may be multiple owners of a vehicle 110. In one embodiment, there are three ways to become an owner of a vehicle 110: (1) if the vehicle is unregistered and the user registers as a driver, they automatically become the owner; (2) if the vehicle is already registered and the user registers as a driver, a request is sent to the existing owner or owners who can deny the request, add the user as a driver (but not an owner), add the user as a joint owner, or transfer ownership to the user; and (3) if a driver or ownership request is denied or ignored, the user can open a dispute and provide an image of their driver's license and registration for human review. Assuming the user is verified as an owner of the vehicle 110, the human reviewer may manually transfer ownership of the vehicle 110 to the user.

A driver is someone who has registered as a driver of a vehicle 110. The user will be able to indicate that they are the current driver of the vehicle 110 and will show up in the vehicle's profile (assuming their privacy settings allow this). In one embodiment, drivers may approve passenger requests but cannot approve other drivers or owners and are not involved in ownership disputes. If a user requests to register as a driver of a vehicle 110 that is already registered, a request is sent to the owner or owners. The owners may be given options to deny the request, add the user as a driver, add the user as an owner, or transfer ownership to the user.

Passenger is a role given to a user to indicate that they are traveling in a vehicle 110. In various embodiments, the passenger role is temporary and expires after a period of time. The period of time may be predetermined (e.g., twenty-four hours) or specified by the user when requesting the passenger role. Alternatively, the passenger role may expire at a predetermined time (e.g., at midnight each day). In one embodiment, there are four ways to become a passenger for a vehicle 110: (1) if the vehicle is unregistered and the user registers as a passenger, they are automatically added as a passenger; (2) if a current driver of the vehicle registers as a passenger, they are automatically added as a passenger; (3) if the vehicle is already registered and a user registers as a passenger, a request is sent to all the owners and drivers and they are given the option to deny, approve once, or approve forever; and (4) if the user registers as a passenger and has previously been “approved forever” by a driver or owner of the vehicle, the user is automatically added as a passenger. While a user is a passenger, they show up on the vehicle's profile and receive messages sent to the vehicle 110.

The temporary driver role allows for drivers to be assigned to a vehicle 110 for a specified period of time. In one embodiment, the temporary driver role is used for rental vehicles 110. When a user rents a vehicle 110 from a rental service, they can mark themselves as a temporary driver and indicate the length of the rental period. During this time the user is treated as the vehicle's owner. After the expiration the rental period, the user is automatically removed and the vehicle 110 reverts to the rental service (if the rental service is registered as an owner with the inter-vehicle communication system) or to being unregistered (if the rental service has not registered its ownership of the vehicle).

Each user may have a “virtual garage’ that indicates the vehicles 110 the user has registered and the corresponding roles the user has with regard to each vehicle. The vehicle app 230 may provide visualizations of the user's virtual garage and other users' virtual garages. For example, a user's virtual garage may include an image of each vehicle 110 the user has registered and provide access to the vehicle's profile (e.g., by clicking, tapping, or otherwise selecting the image of the vehicle). In one embodiment, in addition to displaying the user's registered vehicles 110, a user's virtual garage may include a slot for a “dream car” that the user does not own. The dream car can be used to indicate to other users a vehicle 110 the user hopes to own one day. The dream car can also provide access (e.g., by clicking, tapping or otherwise selecting the image of the dream car) to information about the corresponding vehicle 110, such as current availability and prices in local dealerships.

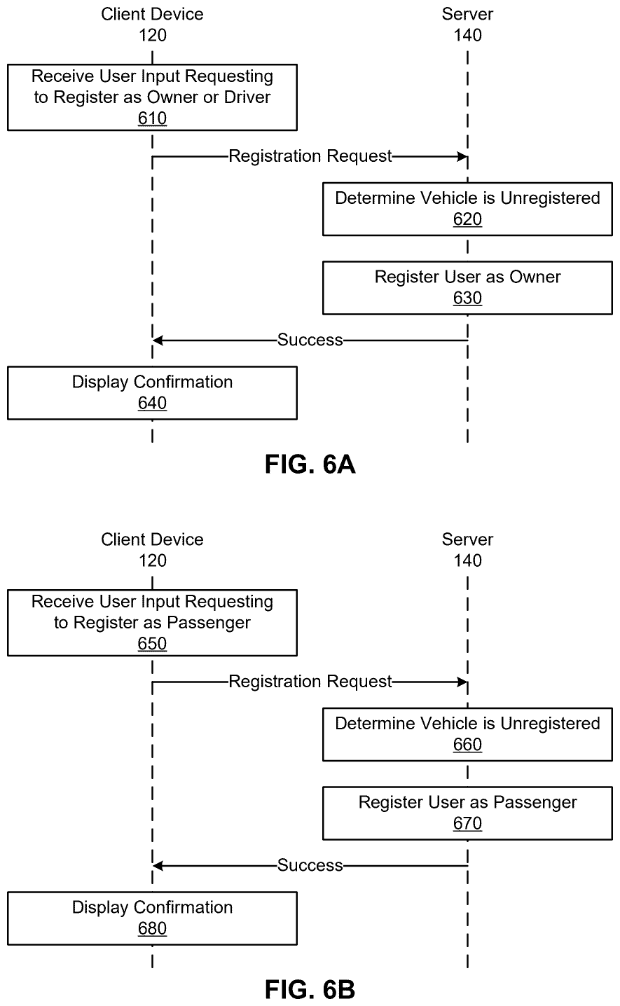

FIG. 5 illustrates an example set of virtual garages 510 indicating relationships between a set of users and vehicles 110, according to one embodiment. FIG. 5 depicts the virtual garages 510 of four users, Jane and John Doe, their daughter Mary, and Mary's friend, Tom. John's virtual garage 512 indicates that he is the owner of car one 522. This is a saloon style car that he drives day to day. He regularly picks Mary up from her college campus to get lunch with her, so he has registered for Mary to always be accepted as a passenger in car one 522. This is indicated in Mary's virtual garage 516. John occasionally drives car two 524 (Jane's truck) and car three 526 (Mary's hatchback) when the family swap cars for various reasons. Therefore, John is also registered as a driver for car two 524 and car three 536.

Jane's virtual garage 514 indicates that she owns car two 524, her truck that she drives for her business. Jane occasionally drives John's car 522 and Mary's car 526 as they are more convenient for downtown driving than her truck 524. Consequently, Jane is listed as a driver for both vehicles.

Mary's virtual garage 516 indicates that she is the owner of car three 526. This the hatchback she drives day-to-day. She also occasionally drives Jane's tuck 524 when she needs to move furniture and other large items. Therefore, Jane is registered as a driver for Jane's truck 524. As noted previously, John often picks Mary up in his car 522, so Mary is listed as a passenger for that vehicle. Mary is also listed as a passenger for car 528, a convertible. Mary and her friend Tom are planning a road trip to the beach and he has rented the convertible 528 for the week to make the trip in. Consequently, Tom is listed in his virtual garage 518 as a temporary driver for the convertible 528. Tom also occasionally drives Mary's car 526 because he does not own his own vehicle and is thus listed as a driver. Finally, in preparation for their road trip, Mary drove Tom in Jane's truck 524 to take his garbage to the dump. Therefore, Tom is currently listed as a passenger for the truck 524 because his temporary status as a passenger has not yet expired.

FIG. 5 illustrates that, even with only four users and four vehicle 110, a relatively complex network of relationships may be formed. Thus, knowing which user a message should be directed to based on a license plate alone is tricky. Referring back to FIG. 3, the check-in module 320 provides a mechanism to simplify this problem. In particular, the check-in module 320 identifies which user or users are the current driver and passengers for a vehicle 110.

In one embodiment, the vehicle app 230 provides a user interface with which a user can access their virtual garage and select the vehicle 110 they are about to drive. The vehicle app 230 sends an identifier of the vehicle to the server 140 via the network 170 and the check-in module 320 assigns the user as the current driver of the selected vehicle. Similarly, users may indicate via the vehicle app 230 that they are passengers in a specified vehicle 110. As described previously, if the owner of the vehicle 110 has previously set the user to be always approved as a passenger, the check-in module may automatically add the user as a current passenger. Otherwise, the registration module 310 generates a request and sends it to the owner and/or drivers of the vehicle 110 for approval. Assuming approval is granted, the check-in module 320 adds the user as a passenger for the vehicle 110. In another embodiment, a user's client device 120 may automatically identify when the user is in a vehicle 110. For example, if the user's smartphone connects to the vehicle's built-in computer via Bluetooth, the vehicle app 230 may prompt the user to indicate whether they are the driver of a passenger. In yet another embodiment, whenever the user opens the vehicle app 230, they may be prompted to select a vehicle 110 from the user's virtual garage 510 and role with respect to the selected vehicle.

The license plate module 330 identifies vehicles using license plate information provided by client devices 120. In one embodiment, the license plate module 330 receives a license plate number and an issuing entity (e.g., a state) from a client device 120. Alternatively, the license plate module 330 may receive an image of the license plate from the client device 120 and extract the license plate number from the received image. Regardless of how the license plate number is obtained, the license plate module 330 queries the database 390 to determine whether the corresponding vehicle 110 is registered with the inter-vehicle communication system and returns the results to the client device 120 that provided the license plate number. For example, if the license plate number corresponds to a registered vehicle, the license plate module 330 may send the corresponding vehicle profile to the client device 120.

The messaging module 340 routes messages to the client devices 120 of recipients. In one embodiment the messaging module 340 handles two types of message: user messages and vehicle messages. User messages are addressed to one or more specific users. For example, a user may provide a license plate number to the server 140, view the returned vehicle profile, and elect to send a message to the current driver of the vehicle 110. Thus, the message received by the messaging module 340 includes identifiers of the sender and the current driver (e.g., usernames) and message content. In this case, the messaging module 340 sends the message content along with the identifier of the sender to the current driver's client device 120 for display (e.g., in the vehicle app 230).

In contrast, vehicle messages are addressed to a vehicle 110 without identifying a specific user to receive the message. For example, if the owner of the vehicle has set their privacy settings such that the users registered with the vehicle are not visible in the vehicle profile, the sender will be unaware of who is in the vehicle. However, the server 140 does have a record of whether there is a current driver and/or passengers registered for the vehicle. In one embodiment, the messaging module 340 sends a vehicle message to the current driver and any passengers. If any of the recipients respond, the messaging module 340 may treat the response as a user message and begin a user-to-user conversation between the original sender and the user who replied. If there are no drivers or passengers registered for the vehicle 110, the messaging module 340 may save the message (e.g., in the database 390) and deliver it if and when a user registers as a driver for the vehicle. Additionally or alternatively, the message may be delivered to any user who registers as a passenger for the vehicle 110.

The reports module 350 receives reports received from client devices 120 about vehicles 110 and stores them in association with an identifier of the vehicle (e.g., in the database 780). In one embodiment, the vehicle app 230 enables a user to perform a license plate lookup (e.g., using the license plate module 330) and submit a report about the identified vehicle 110. For example, the user can report the vehicle 110 for speeding, involvement in a hit-and-run, or being double parked, etc. Reports can be displayed in the corresponding vehicle profile. In one embodiment, the reports module 350 also generates and maintains driver ratings based on reports submitted regarding vehicles while they are registered as the current driver.

The alerts module 360 generates alerts for display to users (e.g., in the vehicle app 230). Depending on the specific embodiment, the alerts module 360 may support one or more types of alert. Alerts may be displayed to users within the vehicle app 230 passively (e.g., in their human media, as described below) and/or actively (e.g., distributed via a push notification to draw the user's attention to important alerts). One type of alert is generated from user-submitted reports. Certain types of report (e.g., hit-and-run reports) may trigger alerts to users in the vicinity to look out for a particular vehicle. Similarly, alerts to look out for a vehicle or person may be generated externally and distributed through the inter-vehicle communication system. For example, law enforcement may use the system to efficiently distribute Amber Alerts or criminal suspects to watch out for to drivers in an area (e.g., within a specified radius or estimated travel time of a location where an incident occurred, in a specified ZIP code or county, or within a ringfenced area, etc.). Other types of alerts that may be generated externally and distributed through the inter-vehicle communication system include road closures, severe weather warnings, traffic alerts, and the like. As noted previously, in one embodiment, whenever the license plate module 330 looks up a license plate number, it may also check for active alerts associated with the identified vehicle 110.

The human media module 370 provides a set of content items to a client device 120 for display to a user as human media. In various embodiments, the set of content items includes a mixture of messages and comments directed specifically at the user and geo-aware information such as alerts, local recommendations, special offers, and the like. The human media module 370 queries the database 390 for messages and comments using a user identifier (e.g., the user's username), separately queries the database using the current location of the user's client device 120 (e.g., as determined by the positioning subsystem 220) for relevant geo-aware information, and aggregates the results. In one embodiment, the human media module 370 sorts the content items chronologically and provides a predetermined number of most-recent content items to the user's client device 120 for display. In another embodiment, the human media module 370 ranks the content items and selects content items from the entire corpus of possible content items based on the rankings. The rankings may be determined from a mix of user-centric factors, such as interests of the user indicated in the user's profile, and external factors, such as the seriousness or urgency of the information contained in the content items (e.g., an Amber Alert may be highly ranked while an offer for a discount at a local restaurant may have a relatively low ranking). One of skill in the art will appreciate numerous ways in which content items can be ranked a selected for presentation to a user in a content feed.

The driver scoring module 380 assigns scores to drivers based on reports submitted to the system by other users. In one embodiment, all drivers start with a default score which can be lowered based on reports of bad driving. To prevent bad faith manipulation of driving scores, a driver's score may be reduced only if a threshold number of reports (e.g., three) of bad driving are received from distinct users of the system within a threshold time period (e.g., one hour, one day, or one week, etc.). Additionally or alternatively, a driver's score may be increased based on reports of good driving (e.g., if a threshold number of reports of good driving are received within a threshold time period, where the thresholds may be the same or different from those used for bad driving reports). Drivers and/or other users may view driving scores on the drivers' profiles. In some cases, a driver's profile may include an explanation of the driver's current driving score and/or suggestions on how to improve it. In some embodiments, drivers may consent for their driving scores to be provided to third parties for various purposes. For example, a driver may be offered a discount on vehicle insurance by having the system provide a driving score for the driver that is above a threshold.

### Example Methods

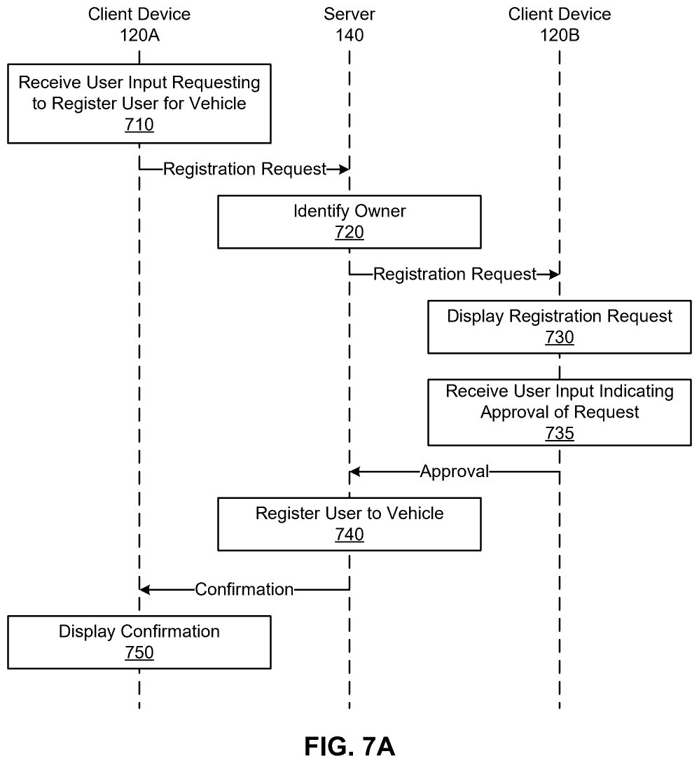

FIGS. 6A through 10 are interaction diagrams illustrating various example methods for providing aspects of the functionality of the inter-vehicle communication system. These figures show specific embodiments in which identified components of the inter-vehicle communication system perform various steps. However, some or all of the steps may be performed by other entities or components. In addition, some embodiments may perform certain steps in parallel, perform steps in different orders, or perform different steps.

FIG. 6A illustrates a method for registering as an owner of an unregistered vehicle 110, according to one embodiment. In the embodiment shown, the method begins with a client device 120 receiving 610 user input from a user requesting to register as the owner or driver of the vehicle 110. For example, the user may fill out a form within the vehicle app 230 identifying the vehicle with a license plate number (or photo of the license plate) and state and check a box indicating they wish to be added as an owner, a driver, or both.

The client device 120 sends the registration request to the server 140 which determines 620 that the vehicle is unregistered and registers 630 the user as an owner. In one embodiment, the server 140 queries the vehicle data 420 in the database 390 using the license plate number and state provided by the user. If no results are returned (or the returned results indicate any previous owners have unregistered the vehicle), the server 140 registers the user as an owner and driver of the vehicle 110. Note that the user is registered as an owner even if they only requested to register as a driver because the system assumes that a driver is also the owner when no other drivers are registered.

The server 140 returns an indication that the registration was successful to the client device 120. The client device 120 displays 640 confirmation of the registration. For example, the vehicle app 230 may display a message indicating that the user has been added as the owner of the vehicle 110.

FIG. 6B illustrates a method for registering as a passenger of an unregistered vehicle 110, according to one embodiment. In the embodiment shown, the method begins with a client device 120 receiving 650 user input from a user requesting to register as a passenger of the vehicle 110. For example, the user may fill out a form within the vehicle app 230 identifying the vehicle with a license plate number (or photo of the license plate) and state and check a box indicating they wish to be added as a passenger.

The client device 120 sends the registration request to the server 140 which determines 660 that the vehicle is unregistered and registers 670 the user as a passenger. In one embodiment, the server 140 determines 660 that the vehicle is unregistered and registers 670 the user as a passenger is the same or a similar manner as described above with reference to FIG. 6A. However, note that the user is not registered as an owner because, unlike with drivers, the system does not assume that a passenger is also the owner, regardless of whether an owner or driver is already registered to the vehicle.

Referring again to FIG. 6B, the server 140 returns an indication that the registration was successful to the client device 120. The client device 120 displays 680 confirmation of the registration. For example, the vehicle app 230 may display a message indicating that the user has been added as the owner of the vehicle 110.

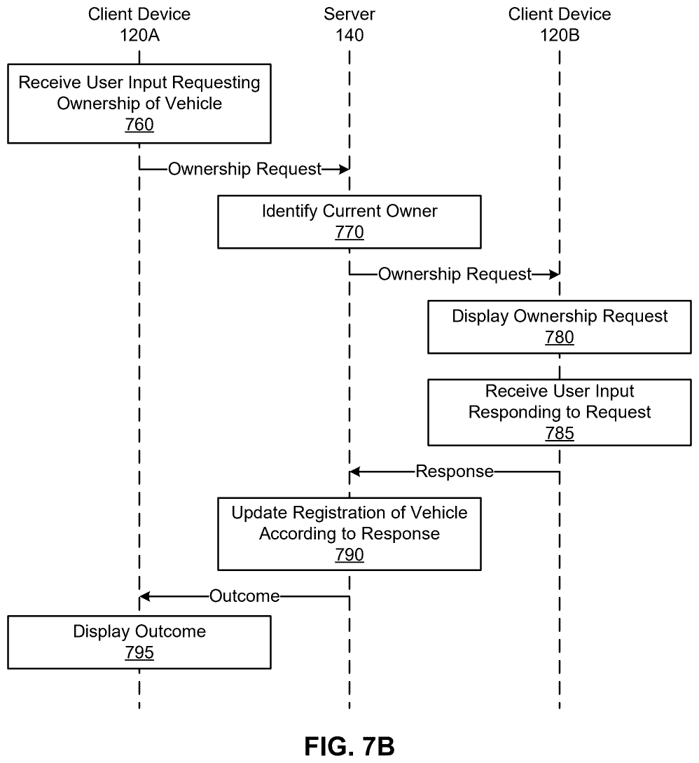

FIG. 7A illustrates a method for registration of a user as a driver or passenger of an already-registered vehicle 110, according to one embodiment. In the embodiment shown, the method begins with a client device 120A receiving 710 user input requesting to register the user for the vehicle 110. For example, the user may fill out a form within the vehicle app 230 identifying the vehicle with a license plate number (or photo of the license plate) and state and check one or more boxes indicating the roles for which they wish to be added.

The client device 120A sends the registration request to the server 140, which identifies 720 the owner (or owners) of the vehicle 110. In one embodiment, the server 140 identifies 720 the owner of the vehicle 110 by querying the vehicle data 420 in the database 390 using the license plate number and state provided by the user. Assuming the vehicle 110 is already registered, the query returns the vehicle's profile that indicates the owner.

The server 140 forwards the registration request to the owner's client device 120B, which displays 730 the registration request and prompts the owner to approve or deny the request. If the owner's client device 120B receives 735 user input indicating approval of the request, it sends an indication of approval to the server 140. If the owner rejects the request or does not respond with a threshold amount of time, the method ends and the user is not registered to the vehicle 110.

Assuming the server 140 receives an indication of approval from the owner's client device 120B, the server registers 740 the user for the requested role or roles with regard to vehicle. The server 140 also sends confirmation that the registration was approved to the user's client device 120A, which displays a confirmation message to the user (e.g., within the vehicle app 230).

FIG. 7B illustrates a method for registration of a user as an owner of an already-registered vehicle 110, according to one embodiment. In the embodiment shown, the method begins with a client device 120A receiving 760 user input requesting to register the user as an owner of the vehicle 110. For example, the user may fill out a form within the vehicle app 230 identifying the vehicle with a license plate number (or photo of the license plate) and state and check a box indicating they wish to be added as an owner.

The client device 120A sends the ownership request to the server 140, which identifies 770 the current owner (or owners) of the vehicle 110. In one embodiment, the server 140 identifies 770 the current owner of the vehicle 110 in the same or a similar manner as described with reference to FIG. 7A. Assuming the vehicle 110 is already registered, the query returns the vehicle's profile that indicates the current owner.

The server 140 forwards the ownership request to the current owner's client device 120B, which displays 780 the ownership request and prompts the current owner to approve or deny the request. In one embodiment, the current owner may deny the request, add the user as a driver (but not an owner), approve the request by adding the user as a co-owner, or approve the request by transferring ownership of the vehicle 110 to the user. Assuming the current owner responds, the current owner's client device 120B receives 785 user input indicating the current owner's decision and sends an indication of the decision to the server 140 as a response.

Assuming the server 140 receives a response from the current owner's client device 120B, the server updates 790 the registration of the vehicle 110 accordingly. If the current owner elected to add the user as a driver or a co-owner, the user data 410 for the user and the vehicle data 420 for the vehicle 110 are updated to reflect the user's new status, but little else changes. If the current owner elected to transfer ownership, the user is added as the new owner and the current owner is unregistered from the vehicle 110, becoming a previous owner. In this case, any messages, reports, and other information relating to the previous owner may be hidden so that the new owner cannot access them. If the current owner rejects the request or does not respond with a threshold amount of time, the user is not registered to the vehicle 110.

The server 140 sends confirmation of the outcome to the user's client device 120A, which displays 795 a message indicating the outcome. to the user (e.g., within the vehicle app 230). If the request was rejected or ignored, the user may submit a dispute as described previously with reference to FIG. 3.

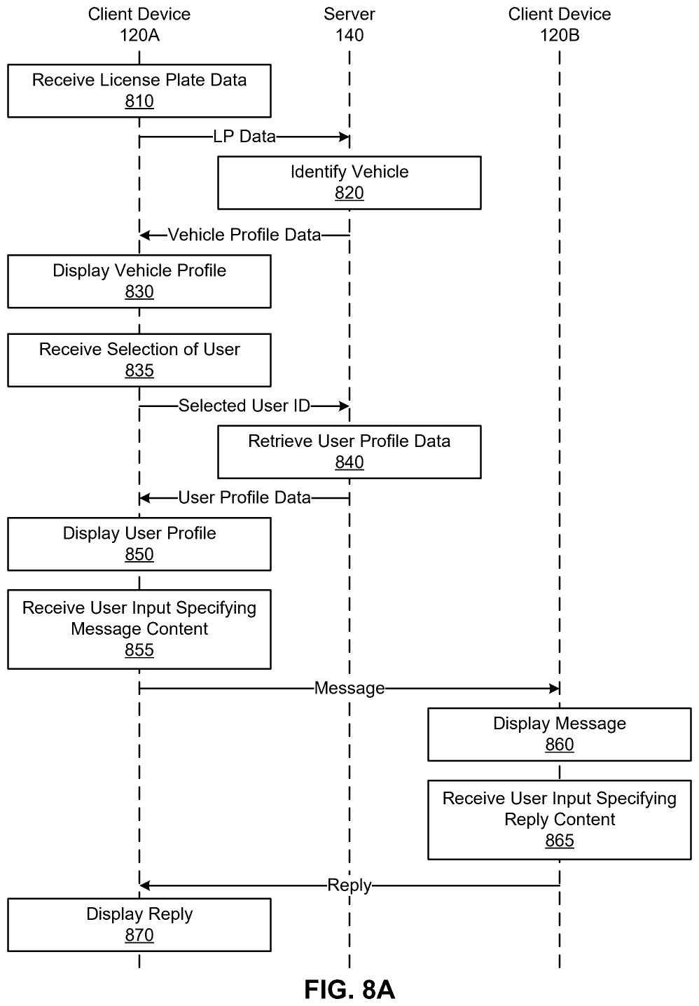

FIG. 8A illustrates a method for messaging a specific user, according to one embodiment. In the embodiment shown, the method begins with a first user's client device 120A receiving 810 license plate data. The license plate data may include a license plate number and state. The license plate data may be derived from an image of a license plate or provided by the first user (e.g., by typing it or using a speech-to-text interface). The first user's client device 120A sends the license plate data to the server 140, which identifies 820 the corresponding vehicle 110 by querying the database 390 with the license plate data.

The server 140 provides the vehicle's profile data to the first user's client device 120A, which displays 830 the vehicle's profile to the first user. The vehicle profile includes a list of users associated with the vehicle 110, such as the current driver and any passengers (assuming the relevant privacy settings allow that information to be shared). The first user's client device 120A receives 835 a selection of a second user from among those associated with the vehicle 110. The first user's client device 120A sends an identifier (e.g., a username) of the second user to the server 140.

The server 140 retrieves 840 user profile data for the second user and sends it to the first user's client device 120A, which displays 850 the user profile of the second user to the first user. The first user's client device 120A provides controls for specifying message content to in conjunction with the user profile. The first user's client device 120A receives 855 user input from the first user specifying message content to send to the second user. In one embodiment, because the first and second users have not previously communicated through the inter-vehicle communication system, the first user is limited to selecting one of a predetermined set of messages to send to the second user at this stage.

Once the first user has selected the message content and indicated the message is ready to send (e.g., by pressing a send button), the message is sent to the second user's client device 120B. Depending on the embodiment and available data pathways, the message may be sent directly to the second user's client device 120B or sent via the server 140. In either case, the second user's client device 120B displays 860 the message in a user interface that also includes controls to enable the second user to respond to the message. Assuming the second user elects to respond, the second user's client device 120B receives 865 user input specifying reply content. In one embodiment, the second user is limited to selecting from a set of predetermined replies. In another embodiment, because the first user elected to make contact, the second user to free to reply with a free text response. In preparing the reply, the second user may also to elect to enable the first user to communicate with them in free text form in future. Alternatively, the second user's decision to respond may automatically grant permission to the first user to send future message using free text.

Once the second user has indicated the reply is ready so send (e.g., by pressing a reply button), the second user's client device 120B sends the reply to the first user's client device 120A. Depending on the available data pathways, the response may be sent directly to the first user's client device 120A or via the server 140. The first user's client device 120A displays 870 the reply. From this point on, the first and second users may continue to exchange messages.

FIG. 8B illustrates a method for messaging a vehicle, according to one embodiment. In the embodiment shown, the method begins much the same as the method of FIG. 8A. The first user's client device 120A receiving 810 license plate data and sends it to the server 140, which identifies 820 the corresponding vehicle 110 and provides the vehicle's profile to the first user's client device 120A, which displays 830 the vehicle profile to the first user. At this point, the methods begin to diverge. Rather than selecting a second user identified in the vehicle profile, the first user instead specifies message content to send to the vehicle 110 via user input. The first user's client device 120A receives 875 this user input and sends the selected message content to the client devices 120 of the current driver of the vehicle 110 and any passengers. These messages may be sent directly to the relevant client devices 120 or via the server 140.

In the example shown, the driver of the vehicle 110 is not looking at their client device 120B and thus ignores 880 the message. However, a passenger opens the vehicle app 230 on their client device 120C, which displays 882 the message from the first user. The passenger's client device 120C receives 885 user input from the passenger specifying reply content that is sent to the first user's client device 120A (either directly or via the server 140). The first user's client device 120A displays 890 the reply, and the first user provides user input specifying additional message content, which is received 895 by the first user's client device 120A and sent to the passenger's client device 120C. From this point on, the first user and the passenger can exchange messages one-to-one, much like the example illustrated in FIG. 8A.

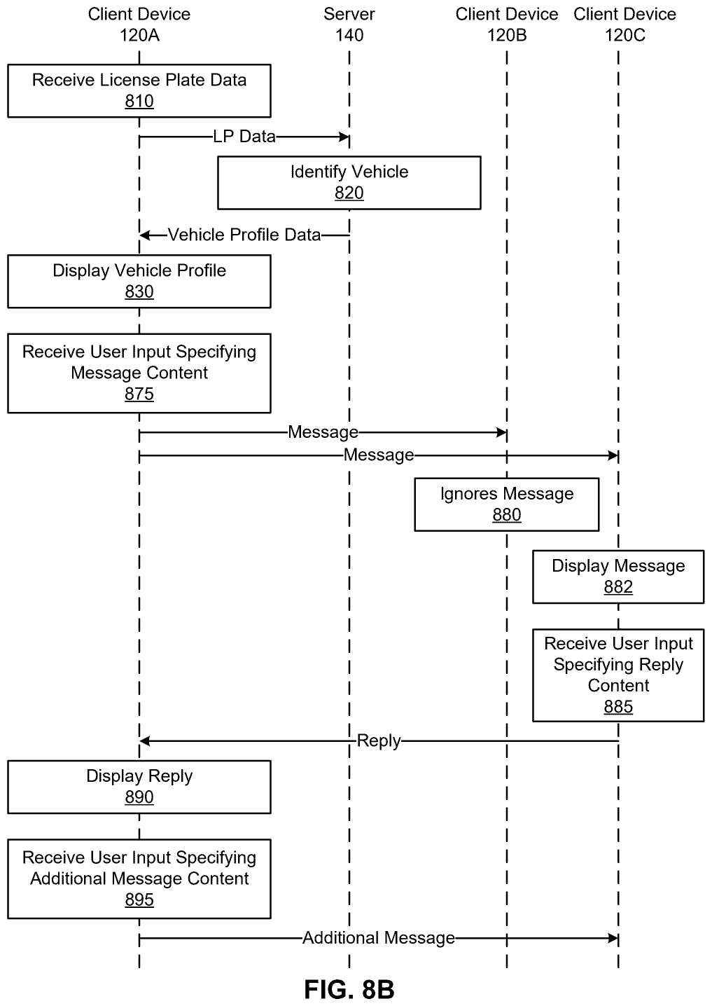

FIG. 9 illustrates a method for distributing an alert to a driver, according to one embodiment. In the embodiment shown, the method begins with a user's client device receiving 910 license plate data. This can occur as part of the user's typical use of the inter-vehicle communication system, such as taking a photo of a license plate or typing in the license plate number to initiate communication with the occupants of a vehicle 110. The user's client device 120 sends the license plate data to the server 140 that, along with performing any tasks relating to the license plate specifically requested by the user, also queries the alert data 440 in the database 390 for any active alerts relating to the vehicle 110. If the query returns one or more active alerts, the server 140 generates 930 alert information and sends it to the user's client device 120.

The user's client device 120 displays 940 the alert information to the user. The alert information may include a mechanism for the user to contact the appropriate authorities. For example, as described previously, if the vehicle 110 is wanted by law enforcement in relation to an Amber Alert, the alert information may be displayed in conjunction with a link to open the client device's phone app with 911 preloaded. Thus, the method of FIG. 9 provides a way for vehicles of interest to be quickly located, as any vehicle on the road using the vehicle using the inter-vehicle communication system essentially becomes an extra pair of eyes in the search.

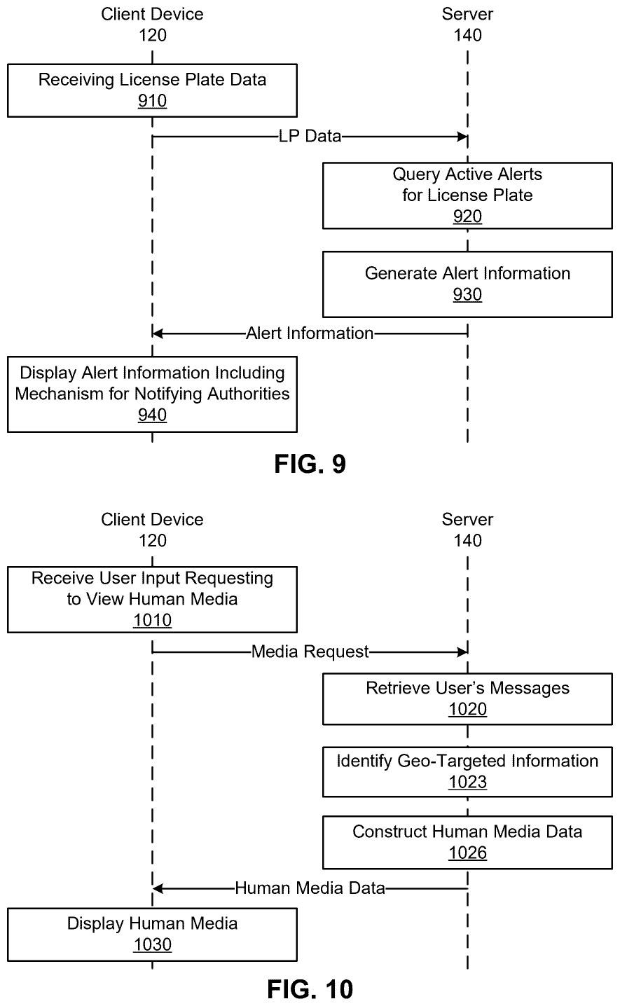

FIG. 10 illustrates a method for providing content items for a user for display as human media, according to one embodiment. In the embodiment shown, the method begins with the user's client device 120 receiving 1010 user input requesting to view the user's human media. For example, the vehicle app 230 may include a tab or other control for accessing the user's human media. On selection of this control, the user's client device 120 sends a request for content items to display to the server 140. Alternatively, the vehicle app 230 may periodically request and cache content items from the server 140 to reduce load times when the user wishes to view their human media and to enable the user to view content that is not too stale if the user is in an area with little or no network connectivity. A human media request may include the geographic location of the client device 120 (e.g., as indicated by the positioning subsystem 220) to enable the inclusion of geo-targeted information.

On receiving a request for human media content items, the server 140 retrieves 1020 messages that other users have posted that identify, tag, or were otherwise directed to the user. The server 140 also identifies 1023 geo-targeted information. In one embodiment, the server 140 does this by querying the database 390 using the geographic location of the client device 120. The query may return any geo-tagged content items in the vicinity of the client device 120. This may include geo-tagged content items within a predetermined distance (e.g., ten, fifty, or one hundred kilometers) of the location of the client device 120, a predetermined estimated travel time (e.g., one, two, or five hours) from the location of the client device as determined by a navigation system, or geo-tagged content items selected using any other suitable technique.

The server 140 constructs 1026 human media data and sends it to the user's client device 120 for display 1030. As described previously, what content is included in the human media provided to the user may be determined in various ways, including sorting and filtering content items chronologically or using ranking algorithm. One of skill in the art will appreciate numerous ways in which content items may be selected for display from a large corpus of potentially relevant information.

### Computing System Architecture

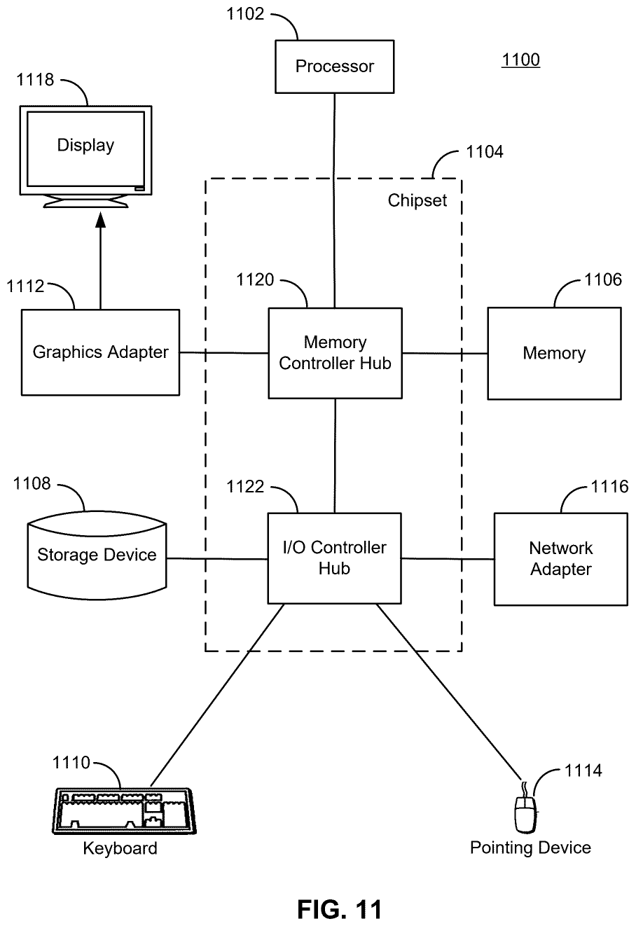

FIG. 11 is a block diagram illustrating an example computer 1100 suitable for use as a client device 120 or server 140. The example computer 1100 includes at least one processor 1102 coupled to a chipset 1104. The chipset 1104 includes a memory controller hub 1120 and an input/output (I/O) controller hub 1122. A memory 1106 and a graphics adapter 1112 are coupled to the memory controller hub 1120, and a display 1118 is coupled to the graphics adapter 1112. A storage device 1108, keyboard 1110, pointing device 1114, and network adapter 1116 are coupled to the I/O controller hub 1122. Other embodiments of the computer 1100 have different architectures.

In the embodiment shown in FIG. 11, the storage device 1108 is a non-transitory computer-readable storage medium such as a hard drive, compact disk read-only memory (CD-ROM), DVD, or a solid-state memory device. The memory 1106 holds instructions and data used by the processor 1102. The pointing device 1114 is a mouse, track ball, touchscreen, or other type of pointing device, and is used in combination with the keyboard 1110 (which may be an on-screen keyboard) to input data into the computer system 1100. The graphics adapter 1112 displays images and other information on the display 1118. The network adapter 1116 couples the computer system 1100 to one or more computer networks.

The types of computers used by the entities of FIGS. 1-3 can vary depending upon the embodiment and the processing power required by the entity. For example, the server 110 might include a distributed database system comprising multiple blade servers working together to provide the functionality described. Furthermore, the computers can lack some of the components described above, such as keyboards 1110, graphics adapters 1112, and displays 1118 or contain additional components, such as microphones, cameras, GPS systems, and the like.

### ADDITIONAL CONSIDERATIONS

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate+/−10% unless another meaning is apparent from the context. From example, “approximately ten” should be understood to mean “in a range from nine to eleven.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for providing inter-vehicle communication, notifications, or alerts. Thus, while particular embodiments and applications have been illustrated and described, it is to be understood that the described subject matter is not limited to the precise construction and components disclosed. The scope of protection should be limited only by the following claims.

What is claimed is:

1. A method comprising:
receiving license plate data responsive to user input;
sending the license plate data to a server;
receiving, from the server and is response to the license plate data, a vehicle profile including information about a vehicle, wherein the server identified the vehicle using the license plate data; and
sending a message to one or more users associated with the vehicle.

2. The method of claim 1, further comprising capturing, responsive to the user input, a photo that includes a license plate of the vehicle, wherein the license plate data is derived from the photograph.

3. The method of claim 1, wherein the license plate data comprises a license plate number and an issuing entity.

4. The method of claim 1, wherein the vehicle profile further includes an identifier of a current driver of the vehicle, and the message is sent to a client device of the current driver.

5. The method of claim 1, wherein the vehicle profile further includes an identifier of a current driver of the vehicle and an identifier of another user of the vehicle, the method further comprising:
displaying the identifier of the current driver and the identifier of the another user; and
receiving a user input selection of the current driver or the another user,
wherein the message is sent to the current driver or the another user, depending on the user input selection.

6. The method of claim 5, further comprising:
displaying a user profile of the current driver or the another user, depending on the user input selection; and
displaying, in conjunction with the user profile, controls for specifying message content to include in the message.

7. The method of claim 1, wherein the vehicle profile further includes an identifier of a current driver of the vehicle and an identifier of another user of the vehicle, and the message is addressed to the vehicle and is delivered to a client device of the current driver and a client device of the another user.

8. The method of claim 1, further comprising:
determining that the first user is a current driver of a second vehicle having a second license plate number; and
sending an indication that the first user is the current driver of the second vehicle to the server,
wherein messages sent by other users to the second license plate number are delivered to the client device of the first user.

9. The method of claim 1, wherein content of the message is selected from a set of predetermined messages.

10. The method of claim 9, further comprising:
receiving a reply to the message from a second user of the one or more users;
displaying the reply from the second user; and
sending an additional message to the second user, wherein content of the additional message is not limited to the set of predetermined messages.

11. The method of claim 10, wherein the message, the reply, and the additional message are sent via the server.

12. The method of claim 1, further comprising:
receiving, responsive to the license plate data, an alert associated with the vehicle; and
displaying the alert to the first user.

13. The method of claim 12, wherein the alert is an Amber Alert, a severe weather alert, a road closure notification, or a report that the vehicle has been stolen.

14. The method of claim 1, further comprising:
receiving user input requesting registration of the first user for a role with regard to a second vehicle;
sending, to the server, a registration request identifying the first user, the role, and the second vehicle;
receiving, from the server, an indication of an outcome of the registration request, wherein the server determined the outcome by:
determining whether the second vehicle is currently registered or unregistered with the server; and
processing the registration request according to whether the second vehicle is currently registered or unregistered.

15. The method of claim 14, wherein the second vehicle is currently registered to a current owner and processing the registration request comprises:
sending the registration request to a client device of the current owner;
receiving approval of the registration request from the client device of the current owner; and
assigning the role to the first user with regard to the second vehicle.

16. The method of claim 15, wherein the role is owner of the second vehicle, and processing the registration request further comprises removing the current owner as an owner of the second vehicle.

17. The method of claim 1, further comprising:
receiving user input requesting to view the first user's human media;
sending a request to the server for content items, the request including a current location of the client device;
receiving, from the server, a set of content items, the set of content items including messages posted to the first user by other users and geo-aware content, the geo-aware content including information related to a geographic area round the current location of the client device; and
displaying at least some of the content items to the first user.

18. The method of claim 17, wherein the server identified the set of content items by:
retrieving a corpus og possible content items;
assigning rankings to the possible content items based on at least one of: recency, interests of the first user, seriousness of the content items, or urgency of the content items; and
selecting the set of content items from among the possible content items based on the rankings.

19. The method of claim 1, wherein the vehicle profile includes a driving score associated with the vehicle, wherein the driving score is based on reports received by the server from other users regarding the vehicle that identify the vehicle using the license plate.

20. A non-transitory computer-readable medium including instructions that, when executed by a client device of a first user, cause the client device to perform operations comprising:
receiving license plate data responsive to user input;
sending the license plate data to a server;
receiving, from the server and is response to the license plate data, a vehicle profile including information about a vehicle, wherein the server identified the vehicle using the license plate data; and
sending a message to one or more users associated with the vehicle.
